(19) United States
(12) Patent Application Publication
(10) Pub. No.: US 2008/0186725 A1
(43) Pub. Date: Aug. 7, 2008

(54) Headlamp For Vehicles

(75) Inventors: Walter Schlager, Bocholtz (NL); Ludo Haenen, Sint Oedenrode (NL); Albrecht Kraus, Kerkrade (NL); Benno Spinger, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/814,686

(22) PCT Filed: Jan. 18, 2006
(86) PCT No.: PCT/IB06/50187

§ 371 Date: Jul. 25, 2007

(30) Foreign Application Priority Data
Jan. 28, 2005 (EP) 05100576.7

(51) Int. Cl. B60Q 1/00

(52) U.S. Cl. 362/507

(57) ABSTRACT

The invention relates to a lamp for vehicles with at least one main light source (2) which in the active operating state of the lamp emits primary light, with at least one light out-let opening (6) and with at least one translucent body (3) arranged in the beam path of the primary light, where into the translucent body or bodies (3) in the active and/or inactive operating state of the at least one main light source (2) can be coupled also secondary light which is emitted by at least one secondary light source (5), and the secondary light can be coupled into the translucent body (3) not parallel to the beam path of the primary light.

The invention relates to a headlamp for vehicles with at least one main light source which in the primary operating state of the lamp emits primary light, with at least one light outlet opening and with at least one translucent body that is arranged in the beam path of the primary light.

To improve traffic safety but also for design reasons, in addition to their primary function (main function) such as for example for a high beam headlamp to generate distance lighting in its active operating state, lamps have further additional secondary functions.

For example these lamps should integrate almost seamlessly into the overall design of the vehicle or emphasize the overall impression of the design. This includes displaying decorative elements or marks, in particular logos, of the manufacturer concerned. Secondly the form of the lamp should be as compact and small or variable as possible so as not to restrict the overall design of the vehicle or corresponding design possibilities.

DE 102 48 660 B4 describes such lamps, the light outlet opening of which in the passive state of the light assumes a color which substantially corresponds to the surrounding color of its immediate environment.

Furthermore it is known to design the light outlet opening of vehicle lamps such that a part area of the light outlet opening differs in transparency from the other part areas of the lamp such that in particular with the lamp activated this part area stands out in appearance. With this solution described in U.S. Pat. No. 5,939,979, it is possible to display decorative elements or marks, in particular logos of the manufacturer concerned. To achieve this differing transparency, partially transparent or opaque bodies are arranged in the beam path of the light of the lamp, which however brings an undesirable or unacceptable deterioration in the characteristics of the lamp light.

This solution cannot be used for applications which do not allow any undesirable or unacceptable deterioration in the characteristics of the lamp light. For example this solution would normally be unacceptable for high beam lamps according to the standards concerned.

The object of the invention is therefore to provide a lamp, a lighting unit and a method for operation thereof which allows, without significant deterioration of the primary lighting function, the achievement of a secondary lighting function so that at least part of the light outlet opening has an appearance which deviates from its direct environment and/or from at least another part of the light outlet opening.

The object of the invention is solved by the features of claim 1.

It is essential to the invention that into the translucent body or bodies in the active and/or inactive operating state of the or at least one main light source can be coupled secondary light which is emitted by at least one secondary light source, where the secondary light can be coupled into the translucent body not parallel to the beam path of the primary light.

This achieves that, in particular decorative elements or marks, in particular logos, can be made clearly identifiable for an external observer of the vehicle.

This is achieved in that at least part of the light outlet opening has an appearance which deviates from its direct environment and/or from at least another part of the light outlet opening. This also includes cases where the light outlet opening or cover plate of the light outlet opening is directly or indirectly perceptible to an observer, usually standing outside the vehicle at the time of perception of the relevant appearance. Directly means in particular the case where the light outlet opening forms part of the outer surface of the vehicle. Indirectly means that in the beam path of the emerging light another outer cover element is arranged which usually comprises a transparent and where applicable colored material.

The term appearance relates in particular to direct perceptions by the human eye; in the sense of the invention however it is not limited to this. For example such an appearance can first be made visible by use of aids known in themselves for the human eye, for example IR-sensitive cameras.

By coupling in the secondary light deviating from the primary light, it is ensured that the light source of the secondary light can be arranged freely or at least additional possibilities are opened for its arrangement in the vehicle. These are preferably placed where no special space need be created for their installation but previously unused space is available. Also in the choice of location further aspects can be taken into account such as the effects of natural heat development of the secondary light source. Such heat is often undesirable in the area of the primary light source. A corresponding selection of light sources is thus possible, the emitted light of which is suitable for coupling into a light guide system such as an optical cable and in which the light can be effectively coupled in.

It is preferred that the translucent body is a transparent body which in particular comprises plastic and/or glass. It is particularly preferred that the transparent body has the form of a cube or plate. One of the two opposing main faces of this plate serves as a light inlet window for the primary light; the second as a light outlet window for the primary and the secondary light. The secondary light is coupled into the plate from at least one of the further four secondary faces of the regularly shaped plate.

Between the two main faces is arranged a multiplicity of slots which are for example worked into the plate material by lasers. Thus the plate material and the air in the slots have different refractive indices. The regularly formed slots which in particular are plate-like are arranged parallel to each other. The slots serve as light outlet openings for the secondary light.

It is further preferred that the translucent body is arranged between at least one main light source and the cover plate of the light outlet opening, on or integrated in the cover plate of the light outlet opening or on or integrated in a further component of the lamp, in particular on its lens. There are therefore different design possibilities depending on the desired design of the area of the vehicle in which the lamp is arranged.

The lamp according to the invention is preferably a distance headlight, dipped headlight, parking light, daytime running light, brake light, indicator light, rear light, position light, fog light or additional headlight, particularly preferably a distance headlight. The solution according to the invention is in principle suitable for all vehicle lamps. This also applies to lamps which with regard to their main function are subject to strict rules or standards such as for example the front headlight of road vehicles with a dipped beam function.

The object of the invention is also achieved by a lighting unit according to the features of claim 10, and a method according to claim 11.

Further details, features and advantages of the invention are apparent from and will be elucidated with reference to a preferred embodiment described hereinafter with reference to the drawings.

In the drawings:

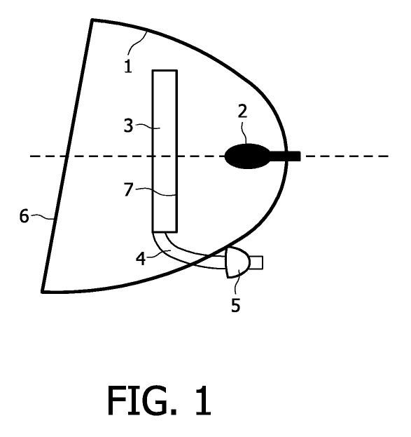

FIG. 1 is a diagrammatic section view of a distance headlight according to the invention, and

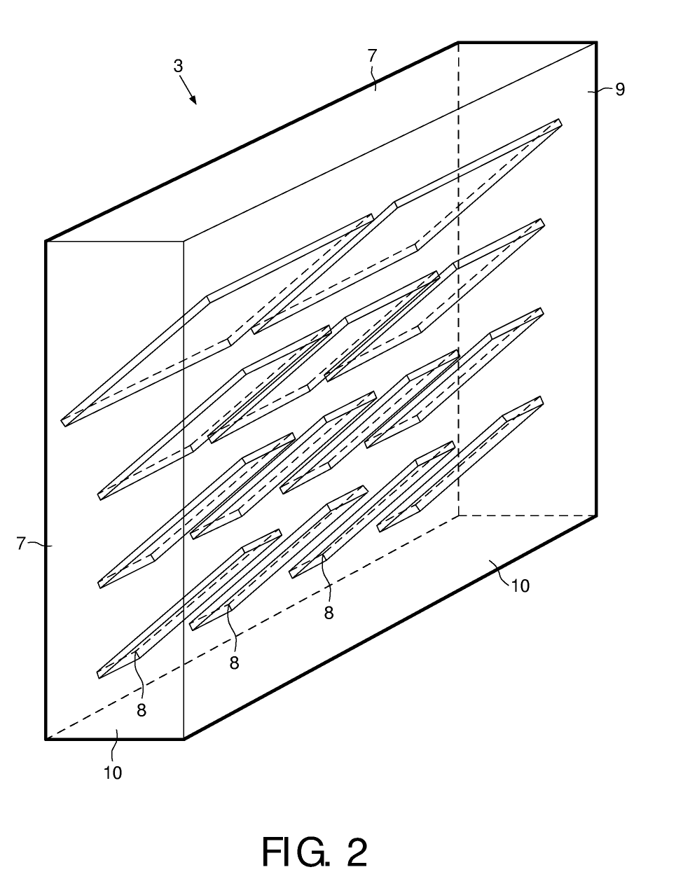

FIG. 2 is a diagrammatic view of a transparent body.

FIG. 1 shows a diagrammatic section view of a lamp according to the invention, here a distance headlight. This lamp in particular has a conventional reflector 1 and a primary light source 2 (main light source), here a halogen lamp, namely a Philips H7. In the beam path of the primary light indicated as a dotted line in FIG. 1 is arranged a translucent body 3. This transparent body 3 is formed plate-like, where the primary light enters and leaves this through its two main faces. One end of the light guide system 4 is connected with the lower of the four secondary surfaces, the other end of the light guide system 4 with the secondary light source 5, here a HiPerReflex lamp by Philips. The secondary light can thus be coupled into the translucent body not parallel to the beam path of the primary light but approximately perpendicular thereto. The lamp also has a light outlet opening 6 in the form of a transparent cover plate. Further components necessary for operation of the lamp are not shown in FIG. 1 where these are conventional components of known type.

FIG. 2 shows a diagrammatic view of the transparent body 3 according to FIG. 1. This translucent body 3 is a transparent body made of plastic. The transparent body 3 has the form of a symmetrically formed plate. One of the two main opposing faces of this plate 3 serves as a light inlet window 7 for the primary light, the other as a light outlet window 9 for the primary and the secondary light. From at least one of the further four secondary surfaces, here the lower secondary surface 10, of the regularly formed plate 3, the secondary light is coupled into the plate 3 in the conventional manner. Between the two main faces is arranged a multiplicity of slots 8 which are worked for example in the material of the plate 3 by lasers. Thus the plastic material of the plate 3 and the air in the slots 8 have different refractive indices.

The regularly formed slots 8 which in particular are made plate-like are arranged parallel to each other. The slots serve as light outlet openings of the secondary light. A defined arrangement of the slots 8 achieves that the desired motif, such as the decorative element or mark, in particular logo, but also words, are visible to an observer. Here it is possible in particular with conventional circuit arrangements to achieve that into the translucent body or bodies, in the active and/or inactive operating state of the or at least one main light source 2, also secondary light can be coupled which is emitted by at least one secondary light source.

By coupling the secondary light into the plate 3 according to the invention it is possible that without significant deterioration in the primary lighting function, here the high beam function, a secondary lighting function is achieved so that at least part of the light outlet opening has an appearance different from its immediate environment and/or at least one other part of the light outlet opening.

1. A headlamp for vehicles with at least one main light source, which in the active operating state of the headlamp emits primary light, with at least one light outlet opening and at least one translucent body, which is arranged in the beam path of the primary light, characterized in that into the translucent body or bodies in the active and/or inactive operating state of the at least one main light source, can be coupled also secondary light which is emitted by at least one secondary light source, where the secondary light can be coupled into the translucent body not parallel to the beam path of the primary light.

2. A headlamp as claimed in claim 1, characterized in that the translucent body is a transparent body which in particular comprises plastic and/or glass and has at least one element for defined direction change of the secondary light.

3. A headlamp as claimed in claim 2, characterized in that the translucent body has slots which are the light outlet openings of the secondary light.

4. A headlamp as claimed in claim 1, characterized in that the translucent body is arranged between at least one main light source and the cover plate of the light outlet opening, on or integrated in the cover plate of the light outlet opening or on or integrated in a further component of the lamp, in particular on a lens.

5. A headlamp as claimed in claim 1, characterized in that the secondary light can be coupled into the translucent body directly or through a light guide system, in particular an optical cable.

6. A headlamp as claimed in claim 1, characterized in that the secondary light can be coupled into the translucent body at approximately right angles to the beam path of the primary light.

7. A headlamp as claimed in claim 1, characterized in that the secondary light source(s) is a HiPerReflex lamp and/or are semi-conductor light sources such as LEDs or laser diodes.

8. A headlamp as claimed in claim 1, characterized in that this is a high beam, low beam, parking light, daytime running light, brake light, indicator light, rear light, position light, fog light or additional headlight, in particular preferably a high beam.

9. A headlamp as claimed in claim 8, characterized in that the secondary light, which coming from the translucent body traverses the light outlet in a high beam opening, is white in appearance.

10. A lighting unit for vehicles with at least one headlamp as claimed in claim 1.
